(19) United States
(12) Patent Application Publication
(10) Pub. No.: US 2004/0158649 A1
(43) Pub. Date: Aug. 12, 2004

(54) System, method and apparatuses for hybrid coax-wireless multimedia networks using 802.11 technology

(76) Inventors: Lior Ophir, Herzeliya (IL); Yigal Bitran, Tel-Aviv (IL); Noam Geri, Los Altos, CA (US); Itay Sherman, Tel-Aviv (IL)

Correspondence Address: TEXAS INSTRUMENTS INCORPORATED, P O BOX 655474, M/S 3999, DALLAS, TX, 75265

(21) Appl. No.: 10/740,312

(22) Filed: Dec. 18, 2003

Related U.S. Application Data
(60) Provisional application No. 60/435,575, filed on Dec. 20, 2002.

(51) Int. Cl. G06F 15/16

(52) U.S. Cl. 709/250

(57) ABSTRACT

A communication network is provided having a wireless connection and a coax connection comprising a network access point coupled to the wireless connection and the coax connection; a first station coupled to the wireless connection; and a second station coupled to the coax connection. Other systems and methods are disclosed.

### FIELD OF THE INVENTION

This invention generally relates to communications systems, and more specifically to multimedia networks.

### BACKGROUND OF THE INVENTION

The IEEE 802.11 standard generally provides specifications for wireless, local area networks (LANs) in the 2.4 GHz bandwidth space and the 5 GHz bandwidth space. This provides users with the ability to connect computers and other devices to each other and the Internet at high speeds and modest costs. The IEEE 802.11 standard allows homes, small offices and corporations to have compatible equipment in their networks regardless of the manufacturer.

As an example, the cable industry is realizing that home networking solutions are useful as they may assist in increasing operator revenues by facilitating distribution of data, voice, video, and multimedia services within the home beyond the PC. Home networks will connect a variety of home devices including PC's, PC peripherals, mobile devices, cellular devices, entertainment devices (such as TVs, Interactive Set-Top Boxes (STBs), DVDs, PVRs, Hi Fi systems and Play Stations), and home appliances. The data traffic within the home will consist of a combination of internally generated data and external data from broadband services.

A standard for communicating data over cable is the Data Over Cable Service Interface Specification (DOCSIS). There have been several iterations thus far of DOCSIS (e.g., 1.0, 1.1 and 2.0). With DOCSIS technology now in place to solve the “last mile” challenge, the cable industry faces a new challenge—delivering broadband services through “the last 100 feet” from the perimeter of the home to the end-user. Home Networking (HN) standards and technologies are being developed to address this need. Home networks will connect a variety of home devices including PC's, PC peripherals, cellular devices, entertainment devices (such as TVs, Interactive Set-Top Boxes (STBs), Hi Fi systems and Play Stations), and home appliances. HN will drive and be driven by a wide range of applications such as:

Communications applications: e.g. fast Internet access from home devices (PC, TV, PDA), digital voice over cable, video streaming into the house;

Productivity applications: e.g. file sharing, printer sharing;

Entertainment application: e.g. video and audio streaming, video on demand, gaming;

Home control applications: e.g. remote control and remote maintenance of devices; and

Security applications: e.g. baby monitor, security camera.

Wireless home networking has emerged as the preferred technology for distribution of data services within the home. With prices comparable to wired alternatives, and with the promise of connectivity throughout the home without any wires, new or old, 802.11b is a natural choice for users who wish to set up a home network. The high demand for 802.11b products in the enterprise market has made 802.11b even more attractive as a home networking technology by driving costs down and offering users a common interface to both home and corporate networks.

The main driver to-date of home networking has been the sharing of a broadband connection over multiple computers in the home. With raw data rates of 11 Mbps and ranges of 300-500 feet, 802.11b offers a very good solution for this need. As new services are introduced over the home network, follow-on standards 802.11 g/a address the growing need for capacity and 802.11e and 802.11i address the growing need for Quality of Service (QoS) and security respectively. However, as the demand for capacity in the home network increases, the coverage of the wireless connection may limit operators' ability to offer new bandwidth intensive services and applications such as in-home video distribution. Whereas the state-of-the-art 802.11a/g standards, with up to 54 Mbps throughput, offer sufficient capacity for distribution of multiple MPEG video streams within the home, the range and coverage of products based on these standards, when operating in the highest throughput mode, may be insufficient in many cases. The high throughput modes of operation of 802.11a/b/g are those most susceptible to path loss due to obstacles such as walls, and to fading due to time-varying multipath, and therefore, reliable delivery of services using these modes of operation cannot be guaranteed.

### SUMMARY OF THE INVENTION

In general, and in a form of the present invention a communication network is provided having a wireless connection and a coax connection comprising a network access point coupled to the wireless connection and the coax connection; a first station coupled to the wireless connection; and a second station coupled to the coax connection. The communication network may further comprise an antenna coupled to the coax connection to provide a combination wireless/coax connection with a third station coupled to the combination wireless/coax connection. This network may be, for example, a home network and the stations may be, for example set-top boxes, computers or other electronic devices. The wireless connections may be accomplished through 802.11 connections. In another form of the present invention a method for transmitting data on a network is provided comprising transmitting first data from a network access point to a first station over a wireless connection coupled to the network access point and the first station; and transmitting second data from a network access point to a second station over a coax connection coupled to the network access point and the second station. The method may further comprise transmitting third data from a network access point to a third station over a combination wireless/coax connection coupled to the network access point and the third station. The data transmitted may be, for example audio and/or video and/or data signals.

### BRIEF DESCRIPTION OF THE DRAWINGS

Particular embodiments in accordance with the invention will now be described, by way of example only, and with reference to the accompanying drawings in which like reference signs are used to denote like parts and in which the Figures relate to the digital system of FIG. 1, unless otherwise stated, and in which:

FIG. 1 is a block diagram of a network that includes an embodiment of the present invention;

FIG. 2 is an exemplary representation of a home network incorporating the present invention;

FIG. 3 illustrates an exemplary implementation the present invention; and

FIG. 4 illustrates an exemplary implementation the present invention;

Corresponding numerals and symbols in the different figures and tables refer to corresponding parts unless otherwise indicated.

### DETAILED DESCRIPTION OF EMBODIMENTS OF THE INVENTION

Although the invention finds particular application to home networking, implemented, for example, in the manners described herein, it also finds application to other forms of communication systems such as those used by small offices and corporations.

The present invention allows operators to overcome the coverage barrier in offering bandwidth intensive services, specifically video distribution, throughout, for example, the home. In an embodiment of the present invention the in-home coax network is used as the backbone for the wireless home network with 802.11 a/b/g as the transmission protocol over the coax lines.

By using the in-home coax network to increase the range and coverage of the wireless network, operators will be able to offer reliable video distribution, as well as other services, throughout the home with guaranteed high capacity coverage at every point in the home while enjoying all the advantages of 802.11b/a/g/e/i, including QoS, security and low cost.

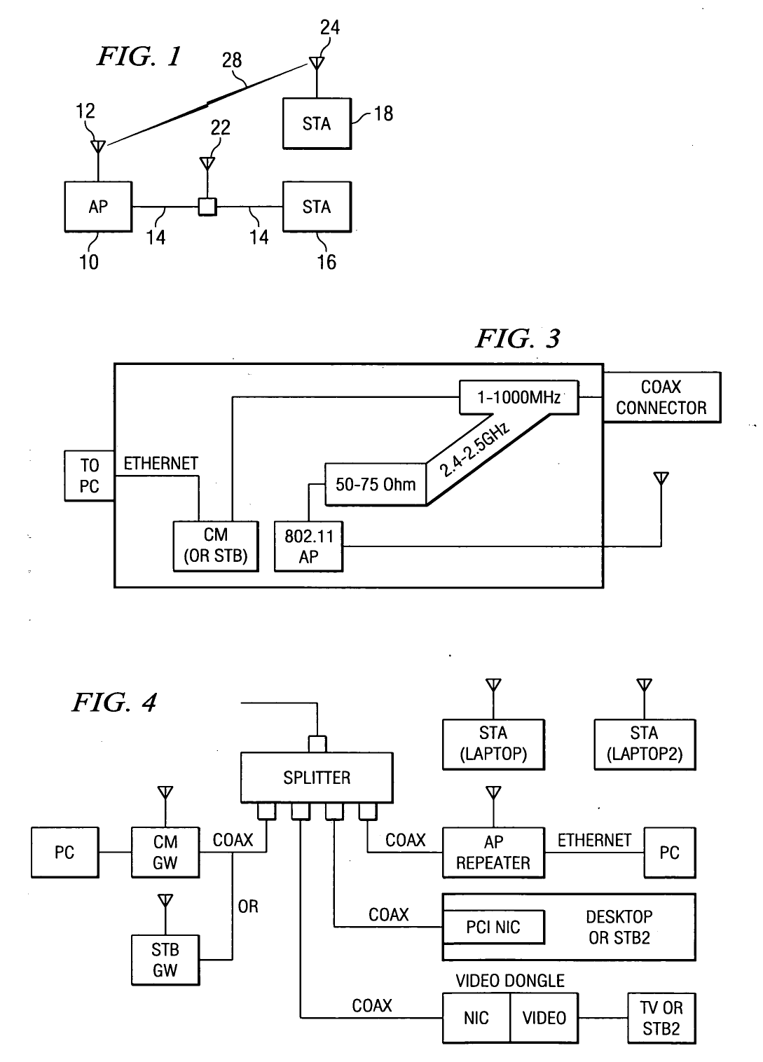

In an embodiment of the present invention, a network, for example a home network, based on 802.11 transmissions both over the air 28 and over coax 14. (The term “802.11”, as used herein, refers to all 802.11 based standards including all the various extensions, i.e. 802.11a,b,g,e and i). FIG. 1 illustrates a basic block diagram of such a combined wireless 28/coax 14 802.11 network. The network illustrated includes an Access Point (AP) 10 with an antenna 12 for wireless 28 802.11 home networking, as well as a coax 14 connection. The network also includes two stations (STA) 16, 18: one 16 connected to the network through a coax line 14 and a second STA 18 connected through a wireless link 24. On one of the nodes of the in-home coax 14 network there is preferably a remote antenna 22.

Every packet that is generated at the AP 10 can be transmitted over the air 28 or over coax 14 or over both. Consequently, in an embodiment, each data packet can reach its destination through one of three signal paths. One possible path is a direct wireless 28 connection using the antenna 12 connected to the AP 10; a second possible path is a combination of coax line 14 until the remote antenna 22, then wirelessly 28 to the wireless station 18; and a third path is confined to coax cable 14. The decision how to transmit each packet may depend on the packet itself or on the destination or on both. The access point 10 may include a table in storage, defining which stations are coupled to the wireless connection. The decision of which path on which to send a given packet may be made to depend on the contents of the table. For example, when a station identification is found in the table, the packet is sent via the wireless connection. In addition, the table may include an entry for each station in the table, defining the transmit power for packets sent to that station. In this way, interference to stations connected via coax line can be minimized. In such configurations, the wireless station transmitter may be provided with a gain control element responsive to a control signal determined by the stored power value in the table. Variations are possible, for example the table may store values identifying the stations coupled to the coax connection.

In most homes the propagation loss of either the 802.11b/g or the 802.11a signal (in 2.4 GHz or 5 GHz respectively) is lower over the coax than over the air especially when accounting for obstructions to the wireless signals such as walls. The coax line 14 therefore allows extending the reach and expanding the coverage of the network by bypassing a high-loss wireless path with a low-loss coax path or a hybrid coax/wireless path. The all-coax 14 path between the AP 10 and stations 16 on the coax 14 network is particularly of high quality, allowing reliable operation at high throughput modes of 802.11a/g (54 Mbps).

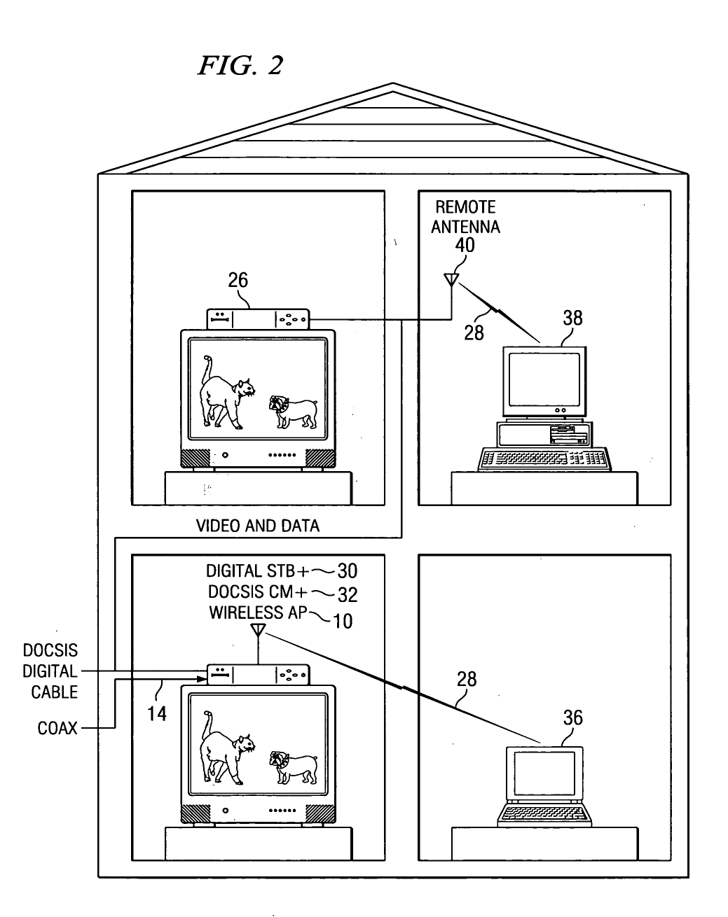

FIG. 2 illustrates an example of such a network in a typical home. The home in this example uses 802.11g for data and video distribution. The Digital Set-Top-Box (STB) 30 on the first floor has an integrated DOCSIS Cable Modem (CM) 32 and an 802.11g AP 10 with data rates of up to 54 Mbps. A diplexer is used to make the connection of the access point to the coax network and the cable modem, such that the diplexer passes the 2.4 GHz band between the access point and the coax network and the <1 GHz band between the CM 32 and the coax network. The two computers 36, 38 in this home share the broadband connection for Internet, email etc. using a wireless 28 link. The computer 36 on the first floor is connected to the STB 30/AP 10 through an 802.11g wireless 28 link. The second computer 38 on the second floor, which is possibly beyond the reach of the wireless signals generated in the STB 30, is connected to the network via the remote antenna 40 on the second floor that extends the reach of the wireless 28 network. An exemplary STB suitable for use in the network of FIG. 2 is shown in FIG. 3.

In the example of FIG. 2, the ability to connect the computer 38 the second floor to the wireless 28 network is one important benefit achieved by this hybrid coax 14/wireless 28 network. A second important benefit is the high capacity connection between the two STBs 26,30 in the house, allowing the distribution of video signals from one room to another. The distance between the two rooms may be enough for a 2-11 Mbps wireless 28 connection that is sufficient for data service (Internet, email etc.), however, higher throughputs of up to 54 Mbps needed for video distribution may require the coax 14 link between the two STBs 26, 30. The high capacity link between the two STBs 26, 30 enables the sharing of recorded material on PVRs, as well as allowing access from all STBs to email, Internet etc. The STB 30 with AP 10 can become the home media center with stored video and audio, with other scaled-down STBs 30 having access to this information through the coax 14 network. All STBs could also have access to data services and computer resources in the home such as printers, scanners, cameras etc.

The QoS capabilities of 802.11e will ensure efficient use of the shared medium, as well as guarantee allocation of bandwidth and limit latency for services requiring QoS. CableHome™ functions implemented in the STBs 26, 30 will facilitate the management of the home network.

The combination of a high capacity coax 14 channel and 802.11e 28 assures operators that bandwidth intensive services such as video distribution can be delivered reliably and consistently between stations on the coax network.

Various solutions addressing the problem of multimedia distribution within the home have been proposed to cable operators. Below is a comparison of these solutions to the present invention.

Analog Distribution—Analog distribution provides a simple solution to the problem of video distribution within the home, with the distinct advantage of not requiring a separate converter box to decode the upconverted video signal. However, this solution is very limited both in its functionality and in its quality. Data delivery, including remote control data, will require a separate medium and additional components, and the quality of the picture can be poor due to micro-reflections in the coax channel. The digital signal of 802.11 is much more robust to micro-reflections, providing consistent and reliable delivery of video as well as high-speed data over the in-home coax network.

Pure 802.11a/b/g+e network—While providing in most cases complete home coverage at rates that support the sharing of the broadband connection for data services throughout the house, it may be insufficient for multimedia distribution. The high throughput modes of operation are the ones most susceptible to wireless path loss and multipath, and coverage for modes that can support video distribution may not be complete.

To expand the reach of the network, wireless repeaters can be used. Repeaters indeed improve the coverage (at the expense of additional spectrum usage), however without careful planning complete coverage is still not guaranteed, and this solution is less robust and more expensive than the hybrid coax/wireless solution of the present invention.

HPNA and HPNA over cable—HPNA 2.0 has not been successful in the market as a home networking technology. Even though its data rates are sufficient for high-speed data service, it has lost market share to the much more popular wireless alternatives. Coverage in many homes is incomplete due to locations of phone outlets, and the use of the phone wire for home networking is not as intuitive to many users as wireless. In fact, as the number of silicon and system vendors developing 802.11 based solutions has increased dramatically, the number of silicon and system vendors developing HPNA based products has decreased, making this technology even less attractive due to lack of competition.

For multimedia applications, HPNA 2.0 is generally not well suited. Practical data rates are not high enough for video distribution, and the QoS mechanisms in the specification are minimal leading to inefficient usage of the shared medium and not allowing operators to guarantee QoS for revenue services. The next generation standard HPNA 3.0 may address this problem, however it still has many of the other problems that made HPNA 2.0 generally unattractive as a home networking technology.

There have also been proposals for using HPNA 2.0 over cable. However, unlike the high rate modes of 802.11g/a with the QoS option, HPNA 2.0 is not capable of distributing multiple MPEG streams over the coax cable due to insufficient throughput and lack of QoS.

In addition, HPNA over cable requires frequency conversion in order not to interfere with cable upstream transmissions (the spectrum of HPNA 2.0 overlaps with the cable upstream spectrum). This introduces a non-standard element to this solution, requiring additional components to the ones used in phone-line HPNA, and requiring an additional standard if multi-vendor interoperability is to be achieved. The frequency conversion may also be a problem for standard HPNA components given that HPNA 2.0 does not allow such conversion.

Moreover, to bridge between the coax and phone network, there needs to be at least one point in the house where coax and phone lines meet. Since in many homes coax and phone outlets are on opposite sides of the rooms, bridging the two networks may not be as simple as in the wireless case.

Also, given the popularity of wireless home networking, it is likely that wireless home networking may still be required at the AP. Wireless handheld devices, and corporate computers equipped with a wireless LAN interface, as well as other devices not near a phone or coax outlet, cannot be served by a HPNA coax/phone-line solution. Complementing HPNA with 802.11 will lead to an inefficient, redundant solution compared to the 802.11 coax/wireless solution.

Dedicated coax transceiver (‘HomeCNA’)—Coax based home networking solutions that use a non-standard transmission protocol has also been proposed. Indeed, an optimized protocol for delivering multimedia over coax can provide a good technical solution, but it is less likely to be adopted than a solution that is already based on an existing standard, especially one so popular as 802.11b/a/g. Developing a new dedicated standard and new components for cable home networking is a long and expensive proposition. Any technical advantages that such an approach may have over using 802.11b/a/g as the transmission protocol are by far outweighed by the advantages of relying on existing, proven standards and, more important, existing 802.11 silicon.

Even if such an approach is adopted, STBs will still require another home networking technology, in addition to the coax networking technology (presumably wireless), to connect to devices that are not near a coax outlet. This is an inefficient (and costly) solution compared to a single 802.11 interface in the STB that transmits both over the air and over the coax.

While dedicated coax home-networking solutions may claim a higher throughput than those supported today by 802.11 (100 Mbps and above compared to 54 Mbps), it is worth noting that 802.11 has a dedicated task group looking at higher rate extensions to 802.11 that will provide even greater capacity for bandwidth intensive applications and services.

In an embodiment of the present invention, a hybrid coax-wireless home network for bandwidth intensive multimedia applications and services using existing 802.11 standards and components is provided. With data rates of up to 54 Mbps, guaranteed QoS and complete home coverage, operators can now have a solution that will allow them to deliver and distribute reliably throughout the home services that require both high capacity and guaranteed QoS such as video distribution.

By using the existing 802.11 standard, operators ensure the availability and interoperability of components from multiple vendors and take advantage of the competition and high volume in the 802.11 market space leading to a low cost, low risk solution.

The popularity of 802.11 both in the home and enterprise space, and the many 802.11 based products such as notebooks with integrated wireless, wireless enabled PDAs, and 802.11b security cameras, will also facilitate wide adoption of this hybrid coax-wireless 802.11 home multimedia network. FIG. 4 illustrates one of many exemplary network configurations incorporating a variety of components, including laptops, PCs, televisions, and gateways (GW).

Thus, a system, method and apparatuses are provided for improving data transmission in a communication system. While the invention has been described with reference to illustrative embodiments, this description is not intended to be construed in a limiting sense. Various other embodiments of the invention will be apparent to persons skilled in the art upon reference to this description. For example, while the present invention is described with respect to home networking, it is applicable other forms of networks. Although specific embodiments address specific devices connected to the network, any device that may be connected to a network may be potentially used with the present invention. Moreover, a person skilled in the art, from the descriptions of the illustrative embodiments herein, would recognize other embodiments for practicing the present invention. It is therefore contemplated that the appended claims will cover any such modifications of the embodiments as fall within the true scope and spirit of the invention.

What is claimed is:

1. A communication network having a wireless connection and a coax connection comprising:
a. a network access point coupled to the wireless connection and the coax connection;
b. a first station coupled to the wireless connection; and
c. a second station coupled to the coax connection.

2. The communication network of claim 1 wherein an antenna is coupled to the network access point to provide the wireless connection.

3. The communication network of claim 1 further comprising an antenna coupled to the coax connection to provide a combination wireless/coax connection.

4. The communication network of claim 3 wherein a third station is coupled to the combination wireless/coax connection.

5. The communication network of claim 1 wherein the network is a home network.

6. The communication network of claim 1 wherein the first station is a set-top box.

7. The communication network of claim 1 wherein the first station is a computer.

8. The communication network of claim 1 wherein the wireless connection is an 802.11 connection.

9. A method for transmitting data on a network comprising:
a. transmitting first data from a network access point to a first station over a wireless connection coupled to the network access point and the first station; and
b. transmitting second data from a network access point to a second station over a coax connection coupled to the network access point and the second station.

10. The method of claim 9 further comprising transmitting third data from a network access point to a third station over a combination wireless/coax connection coupled to the network access point and the third station.

11. The communication network of claim 1 wherein the coax connection is implemented according to IEEE 802.11 standard specifications over the coax cables

12. The communication network of claim 1 wherein each packet may be selectably transmitted over the air or over coax or over both the air and the coax.

13. The communication network of claim 12 wherein the decision whether to transmit each packet over the air or over coax or over both the air and the coax depends on the packet to be transmitted.

14. The communication network of claim 12 wherein the decision whether to transmit each packet over the air or over coax or over both the air and the coax depend on the destination of the packet.

15. The conmmunication network of claim 12 wherein the access point holds a table storing values identifying stations coupled to the wireless connection.

16. The communication network of claim 15 wherein the decision whether to transmit each packet over the air or over coax or over both the air and the coax depend on the values stored in the table.

17. The communication network of claim 12 wherein the access point holds a table storing values identifying stations coupled to the coax connection

18. The communication network of claim 17 wherein the decision whether to transmit each packet over the air or over coax or over both the air and the coax depend on the values stored in the table.

19. The communication network of claim 12 wherein the access point includes a table storing values defining transmission power to stations communicating via the wireless connection.

20. The communication network of claim 19 wherein the values stored in the table are selected to minimize interference to devices connected via the coax connection.

21. The communication network of claim 20 wherein the transmit power of a packet depends on a value stored the table.

22. The communication network of claim 12 further comprising of a Cable Modem

23. The communication network of claim 22 wherein the node of the access point connected to the coax network and the Cable modem connected to the coax network are connected through a diplexer.

24. The communication network of claim 12 wherein the access point serves as a repeater between the coax network and the wireless network

25. The communication network of claim 12 including a primary server including the network access point and a secondary server, wherein the primary server is a:
a. Primary set top box, or
b. Primary PVR, or
c. Primary entertainment server

26. An apparatus comprising of two nodes:
a. One node that can be connected to wireless LAN device
b. One node that can be connected to the coax network

27. An apparatus of claim 26 further comprising of automatic gain control element

28. An apparatus of claim 26 further comprising of switching elements

29. An apparatus of claim 28 wherein the switching element performs switching between the receive and the transmit paths
